(19) United States
(12) Patent Application Publication
(10) Pub. No.: US 2026/0241887 A1
(43) Pub. Date: Aug. 20, 2026

(54) CURTAIN AIRBAG DEVICE

(71) Applicant: TOYODA GOSEI CO., LTD., Kiyosu-shi (JP)

(72) Inventors: Yuto NAKAMURA, Aichi (JP); Junpei HAMAMOTO, Aichi (JP); Makoto YAMANAKA, Aichi (JP)

(21) Appl. No.: 19/539,997

(22) Filed: Feb. 13, 2026

(30) Foreign Application Priority Data
Feb. 17, 2025 (JP) 2025-022965

(51) Int. Cl. B60R 21/2338; B60R 21/231

(52) U.S. Cl. CPC B60R 21/2338; B60R 21/23138

(57) ABSTRACT

A curtain airbag device attached to a roof side rail portion of an upper portion of a vehicle includes: a bag body configured to be inflated by being supplied with inflation gas to be deployed along a side wall of the vehicle in a downward direction to a lower portion of a window portion provided on the side wall so as to cover the window portion; and a tether that is a belt-shaped member with two end portions being fixed to front and rear of the window portion, and with a part other than the two end portions being fixed to a bag lower portion including a lower end of the bag body. The bag body includes an inflation portion and a non-inflation portion. In a state in which the bag body is deployed, an inflation portion lower end does not cover a lower edge portion of the window portion.

### CROSS-REFERENCE TO RELATED APPLICATIONS

This application is based upon and claims the benefit of priority from prior Japanese patent application No. 2025-022965, filed on Feb. 17, 2025, the entire contents of which are incorporated herein by reference.

### TECHNICAL FIELD

The present disclosure relates to a curtain airbag device.

### BACKGROUND ART

In a curtain airbag provided on a side wall of a vehicle, a lower end portion of the curtain airbag is usually located at a lower edge of a window portion in the side wall of the vehicle. In a curtain airbag in WO2012/017987, this lower end portion is extended so as to overlap a door trim. Accordingly, the curtain airbag in WO2012/017987 covers the window portion of the side wall of the vehicle and a part of the door trim. Therefore, the curtain airbag in WO2012/017987 can prevent the occupant from being released from the vehicle when the vehicle rolls over.

The curtain airbag in WO2012/017987 is stored in a roof side rail portion of the vehicle in a folded state before being deployed.

### SUMMARY OF INVENTION

The extension of the lower end portion of the curtain airbag increases the size of the curtain airbag. Further, a larger amount of gas is required to inflate the entire curtain airbag including the non-extended portion. That is, the capacity of the inflator that injects gas also increases. As a result, the size of the roof side rail portion in which the curtain airbag is stored also increases, which causes a problem of compressing the space inside the vehicle.

Therefore, there has been a demand for a technique for preventing an increase in the size of the curtain airbag while preventing the occupant from being released from the vehicle when the vehicle rolls over.

The present disclosure may be implemented by the following aspects.

(1) According to an aspect of the present disclosure, there is provided a curtain airbag device that is attached to a roof side rail portion of an upper portion of a vehicle. The curtain airbag device includes: a bag body configured to be inflated by being supplied with inflation gas to be deployed along a side wall of the vehicle in a downward direction of the vehicle to a lower portion of a window portion provided on the side wall so as to cover the window portion; and a tether that is a belt-shaped member with two end portions being fixed to front and rear of the window portion of the vehicle, and with a part other than the two end portions being fixed to a bag lower portion that is a portion of the bag body including a lower end of the bag body. The bag body includes an inflation portion into which the inflation gas is supplied, and a non-inflation portion into which the inflation gas is not supplied. In a state in which the bag body is deployed, an inflation portion lower end does not cover a lower edge portion of the window portion.

In such an aspect, the bag body is deployed so as to cover the window portion. Further, the tether, which is a belt-shaped member, is implemented such that the two end portions are fixed to the front and rear of the window portion of the vehicle, and a part other than the two end portions is fixed to the bag lower portion. That is, the curtain airbag device reduces deformation of the bag body in the left-right direction of the vehicle as compared with an aspect in which the tether is not provided. More specifically, the curtain airbag device can reduce deformation of the bag body toward the outside of the vehicle when the bag body receives a force from the inside toward the outside of the vehicle. Further, the bag body does not cover the lower edge portion of the window portion. Therefore, the curtain airbag device can prevent an increase in the size of the bag body as compared with an aspect in which the lower end portion of the bag body is extended.

(2) The curtain airbag device according to the above aspect, the tether may be fixed to the non-inflation portion.

In such an aspect, the tether is fixed to the non-inflation portion that is less likely to be deformed than the inflation portion of the bag body. That is, the curtain airbag device is designed so as to be easily fixed to the bag body as compared with an aspect in which the tether is fixed to the inflation portion of the bag body.

(3) In the curtain airbag device according to the above aspect, the bag body may have a cabin inner side surface facing an inside of the vehicle and a cabin outer side surface that is opposite to the cabin inner side surface, and in the state in which the bag body is deployed, the tether may be located at the cabin outer side surface

With such an aspect, the curtain airbag device easily reduces deformation of the bag body toward the outside of the vehicle. More specifically, when the protected object collides with the cabin inner side surface of the bag body, the tether supports the bag body from the cabin outer side surface of the bag body. That is, when the bag body receives a force from the inside to the outside of the vehicle, the bag body is less likely to jump out to the outside of the vehicle. Therefore, in the curtain airbag device, the bag body is more easily fastened to the inside of the vehicle than in an aspect in which the tether is fixed to the cabin inner side surface of the bag body.

(4) In the curtain airbag device according to the above aspect, the tether may be fixed within a range of 1/3 of a bag height from the inflation portion lower end.

With such an aspect, the movement of the inflation portion lower end can be more effectively reduced than when the tether is fixed at a position higher than 1/3 of the bag height. Therefore, in the curtain airbag device, a gap between the window portion and the bag body is less likely to be generated.

(5) In the curtain airbag device according to the above aspect, the two end portions may be fixed to front and rear of the roof side rail portion, and a length of the tether may be larger than a length of the roof side rail portion, and is smaller than a shortest length connecting two ends of the tether along a surface of the bag body in a maximum inflated state in a curtain airbag device without the tether.

With such an aspect, the curtain airbag device can reduce deformation of the bag body and movement of the inflation portion lower end such that the tether extends longer than the shortest length connecting the two end portions.

### BRIEF DESCRIPTION OF DRAWINGS

Exemplary embodiment(s) of the present invention will be described in detail based on the following figures, wherein:

FIG. 1 is a view illustrating a curtain airbag device in a vehicle;

FIG. 2 is a view illustrating a tether located on a cabin outer side surface of a bag body;

FIG. 3 is a view illustrating a cross section of the bag body in a deployed state;

FIG. 4 is a view illustrating a state in which a head impactor collides with the bag body illustrated in FIG. 3; and

FIG. 5 is a view illustrating tethers located on the cabin outer side surface and a cabin inner side surface of the bag body.

### DESCRIPTION OF EMBODIMENTS

### A. First Embodiment

### A-1. Configuration of Device

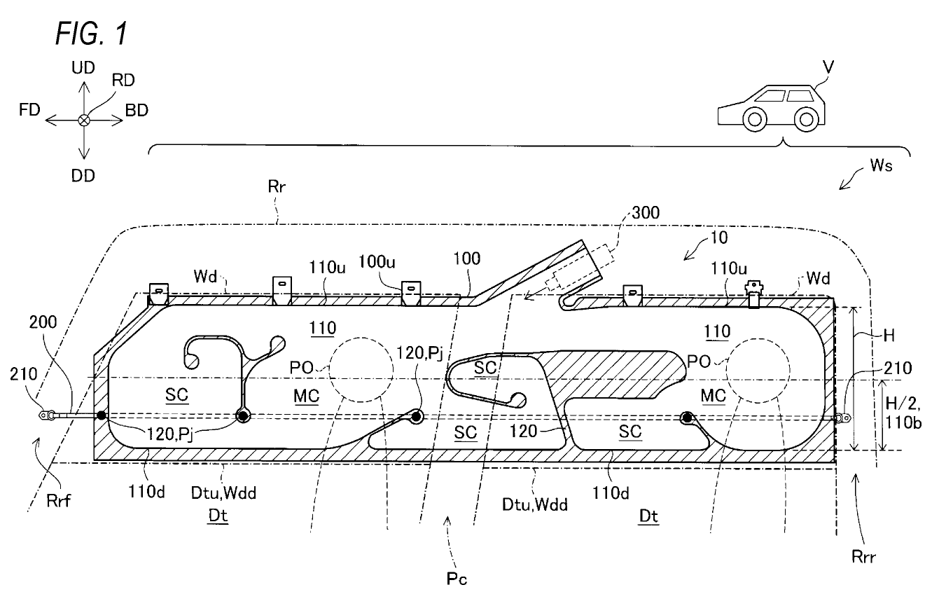

FIG. 1 is a schematic view illustrating a curtain airbag device 10 in a vehicle V. The curtain airbag device 10 is mounted on the vehicle V. The curtain airbag device 10 is activated when the vehicle V collides or rolls over, and protects a protected object PO. More specifically, the curtain airbag device 10 prevents the protected object PO from colliding with a window portion Wd of the vehicle V. Further, the curtain airbag device 10 reduces the risk that the protected object PO is released from the window portion Wd to the outside of the vehicle. The curtain airbag device 10 is designed to conform to the standards of Federal Motor Vehicle Safety Standards (FMVSS). In particular, the curtain airbag device 10 is designed to satisfy FMVSS 226, which is a standard for reducing the release of the protected object PO to the outside of the vehicle.

In the description of the present specification, a forward direction FD indicates the front in the traveling direction of the vehicle V. A backward direction BD indicates the rear in the traveling direction of the vehicle V. An upward direction UD indicates an upward direction in the height direction of the vehicle V. A downward direction DD indicates a downward direction in the height direction of the vehicle V. In the present specification, a side in the upward direction UD is treated as "upper", and a side in the downward direction DD is treated as "lower". Further, a direction along the forward direction FD and the backward direction BD is referred to as a front-rear direction. A direction along the upward direction UD and the downward direction DD is referred to as an upper-lower direction. A direction perpendicular to the front-rear direction and the upper-lower direction is referred to as a left-right direction. FIG. 1 illustrates a side wall Ws of the vehicle V in a right direction RD in the left-right direction. In the following description, these directions are also used in a case of indicating a portion in the configurations provided in the curtain airbag device 10.

FIG. 1 illustrates a state in which a bag body 100 of the curtain airbag device 10 is deployed along the side wall Ws. The protected object PO in FIG. 1 represents an occupant in a first row of the vehicle V and an occupant in a second row of the vehicle V. Further, a circular portion of the protected object PO represents the head of the occupant. In FIG. 1, in order to facilitate understanding of the technology, a roof side rail portion Rr, a center pillar Pc, and the like are illustrated to be larger than the curtain airbag device 10.

The curtain airbag device 10 includes the bag body 100 (see the middle part of FIG.

1), a tether 200 (see the lower part of FIG. 1), and an inflator 300 (see the middle center part of FIG. 1). Further, the curtain airbag device 10 is attached to the roof side rail portion Rr at the upper portion of the vehicle V. More specifically, before the curtain airbag device 10 is activated, the bag body 100, the tether 200, and the inflator 300 are housed in the roof side rail portion Rr. After the curtain airbag device 10 is activated, the bag body 100 and the tether 200 are deployed from the roof side rail portion Rr.

The bag body 100 is stored in a folded state together with the tether 200. Further, the bag body 100 and the tether 200 are partially fixed to the roof side rail portion Rr. More specifically, an upper end 100u of the bag body 100 and two end portions 210 of the tether 200 are fixed to the roof side rail portion Rr. In FIG. 1, the tether 200 is illustrated in a straight line for easy understanding of the technique. However, since the tether 200 is provided along a cabin outer side surface 110sb of the bag body 100 as will be described later, the tether 200 is longer than the length of the roof side rail portion Rr. The operation of the curtain airbag device 10 will be described in detail later.

The roof side rail portions Rr are located at two ends of the upper portion of the vehicle V in the left-right direction. That is, the roof side rail portion Rr is a part of the frame of the vehicle V extending in the front-rear direction along the ceiling portion of the vehicle V. More specifically, the roof side rail portion Rr includes a front pillar Rrf and a rear pillar Rrr, and connects the pillars via the upper end of the side wall Ws. The window portion Wd is located between the front pillar Rrf and the rear pillar Rrr in the front-rear direction and is located in the downward direction DD of the upper end of the side wall Ws. Further, a lower edge portion Wdd of the window portion Wd overlaps an upper end portion Dtu of a door trim Dt.

The inflator 300 injects inflation gas into the bag body 100. The inflator 300 is located at an upper opening of the curtain airbag device 10 in FIG. 1. The inflator 300 is operated by a control unit (not shown) mounted on the vehicle V to inject inflation gas in response to detection or prediction of a collision. Accordingly, the inflator 300 inflates the bag body 100.

The bag body 100 is inflated by being supplied with inflation gas. Further, as the bag body 100 inflates, the bag body 100 deploys along the side wall Ws of the vehicle V in the downward direction DD of the vehicle V, and deploys to the lower portion of the window portion Wd in the side wall Ws so as to cover the window portion Wd. "To cover the window portion Wd" does not mean to completely cover the entire window portion Wd, but means to form a range in which the protected object PO can be protected from the upper portion to the lower portion of the window portion Wd. Specifically, after the deployment of the bag body 100, a lower end portion 110d of the bag body 100 is provided close to the upper end portion Dtu of the door trim Dt along the extending direction of the upper end portion Dtu of the door trim Dt. The lower end portion 110d of the bag body 100 is also an inflation portion lower end 110d to be described later.

The bag body 100 constitutes a substantially rectangular bag body in a state in which the bag body 100 is deployed. The bag body 100 is manufactured by a One Piece Woven (OPW) method. That is, the bag body 100 is implemented as an integrated bag body woven by an automatic loom. Alternatively, the bag body 100 may be formed by a method different from the OPW method. For example, the bag body 100 may be implemented by overlapping and sewing a plurality of cloths.

In this manufacturing, the bag body 100 is cut out from a base fabric of a fixed length at the time of manufacturing. Since the bag body 100 according to the present embodiment has a structure in which the lower end portion 110d is not extended in the downward direction DD, the shape of the base fabric at the time of cutting out is close to a square. With such an aspect, the curtain airbag device 10 according to the present embodiment minimizes the waste material of the base fabric. That is, the curtain airbag device 10 according to the present embodiment can improve the material yield as compared with an aspect having the bag body 100 having a structure in which the lower end portion 110d extends in the downward direction DD.

The base fabric is made of, for example, polyethylene terephthalate, and is coated with a resin. The thickness of the base fabric is, for example, approximately 0.7 mm.

The bag body 100 includes an inflation portion 110 to which the inflation gas is supplied and a non-inflation portion 120 to which no inflation gas is supplied. The inflation portion 110 is a portion of the curtain airbag device 10 to which the inflation gas is supplied, except for an upper opening of the curtain airbag device 10 into which the inflator 300 is inserted.

The non-inflation portion 120 controls the flow of the inflation gas supplied to the inflation portion 110. The non-inflation portion 120 is formed by partially joining two pieces of fabric constituting the bag body 100 by sewing. In FIG. 1, the non-inflation portion 120 is a hatched portion of the bag body 100. That is, the non-inflation portion 120 includes a portion along the outer periphery of the bag body 100, a portion extending toward the inside of the bag body 100, and a portion formed in an island shape in the bag body 100. The tether 200 to be described later is joined to a part of the non-inflation portion 120.

In a state in which the bag body 100 is deployed, the inflation portion lower end 110d of the inflation portion 110 is close to the upper end portion Dtu of the door trim Dt along a direction in which the upper end portion Dtu of the door trim Dt extends. Therefore, the inflation portion lower end 110d of the inflation portion 110 does not cover the lower edge portion Wdd of the window portion Wd.

The tether 200 reduces deformation of the bag body 100 and movement of the inflation portion lower end 110d.

The tether 200 is a band-shaped member having rigidity higher than that of the bag body 100. For example, the tether 200 is formed by laminating the same material as the bag body 100. That is, the tether 200 has higher rigidity than the bag body 100 by adjusting the shape. For example, the tether 200 has a rectangular cross-sectional shape, and has a width of approximately 20 mm and a thickness of approximately 3 mm. Such a configuration is implemented by laminating a plurality of base fabrics.

Alternatively, the tether 200 may have higher rigidity than the bag body 100. Therefore, the width may be approximately 10 mm to 30 mm, or the thickness may be approximately 2 mm to 5 mm by laminating two or more base fabrics. Further, the cross section of the tether 200 is not limited to a rectangle and may be a circle. Further, the tether 200 may be made of a material different from the base cloth of the bag body 100. However, such a tether 200 is implemented by methods such as using a material having a large elastic modulus or adjusting the shape.

The two end portions 210 of the tether 200 are fixed to the front and rear of the vehicle V. That is, the two end portions 210 are fixed to the front and rear of the roof side rail portion Rr. More specifically, one end portion 210 of the two end portions 210 is fixed to the vicinity of an end portion of the front pillar Rrf in the downward direction DD, and the other end portion 210 is fixed to the vicinity of an end portion of the rear pillar Rrr in the downward direction DD.

As indicated by a joint portion Pj in FIG. 1, a part of the tether 200 other than the two end portions 210 is fixed to the non-inflation portion 120 of the bag body 100. For example, as shown in FIG. 1, the part is fixed to the non-inflation portion 120 (see a middle central portion) extending toward the inside of the bag body 100, the non-inflation portion 120 (see a middle left portion) formed in an island shape in the bag body 100, and the non-inflation portion 120 (see a middle leftmost portion) along the outer periphery of the bag body 100. The tether 200 is attached and fixed to the non-inflation portion by sewing. Alternatively, the tether 200 may be fixed to the non-inflation portion 120 by welding, bonding with a tape, or tying with a ring-shaped component. In such an aspect, the tether 200 is fixed to the non-inflation portion 120 that is less likely to be deformed than the inflation portion 110 of the bag body 100. That is, the curtain airbag device 10 according to the present embodiment is designed so as to be easily fixed to the bag body 100 as compared with an aspect in which the tether 200 is fixed to the inflation portion 110 of the bag body 100.

In addition, a part of the tether 200 other than the two end portions 210 is fixed to a bag lower portion 110b which is a part of the bag body 100 including the lower end portion 110d of the bag body 100. The bag lower portion 110b is a portion located in the downward direction DD with respect to a position of half H/2 of a bag height H. The bag height H is a length from an inflation portion upper end 110u to the inflation portion lower end 110d in the inflation portion 110.

The length of the tether 200 is larger than the length of the roof side rail portion Rr. More specifically, the length of the tether 200 is larger than the length from the end portion of the front pillar Rrf in the downward direction DD to the end portion of the rear pillar Rrr in the downward direction DD along the direction in which the roof side rail portion Rr extends. The roof side rail portion Rr is longer than a linear distance connecting the two end portions 210 of the tether 200.

The length of the tether 200 is smaller than the shortest length connecting two ends of the tether 200 along the surface of the bag body 100 in the maximum inflated state in the curtain airbag device not including the tether 200. The "curtain airbag device not including the tether 200" is the same as the curtain airbag device 10 according to the present embodiment except for the tether 200. With such an aspect, the curtain airbag device 10 according to the present disclosure can reduce deformation of the bag body 100 and movement of the inflation portion lower end 110d such that the tether 200 extends longer than the shortest length connecting the two end portions 210 of the tether 200.

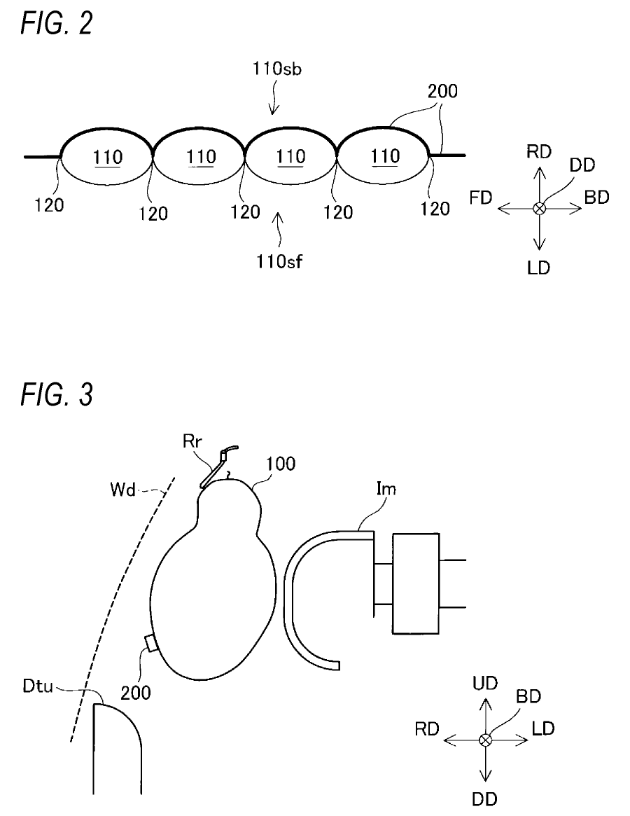

FIG. 2 is a view illustrating the tether 200 located on the cabin outer side surface 110sb of the bag body 100. FIG. 2 is a view illustrating the position of the tether 200 in a cross section of the bag body 100 when the bag body 100 is viewed along the downward direction DD. However, in order to facilitate understanding of the technique, the positions of the inflation portion 110 and the non-inflation portion 120 are illustrated at an equal interval unlike the positions in FIG. 1. In a state in which the bag body 100 is deployed, the tether 200 is located on the cabin outer side surface 110sb opposite to a cabin inner side surface 110sf facing the inside of the vehicle V in the bag body 100. More specifically, when the bag body 100 and the tether 200 are viewed from the inside toward the outside of the vehicle V along a direction parallel to the left-right direction, the tether 200 is located outside the cabin inner side surface 110sf of the bag body 100. With such an aspect, the curtain airbag device 10 according to the present embodiment easily reduces deformation of the bag body 100 toward the outside of the vehicle V. More specifically, when the protected object PO collides with the cabin inner side surface 110sf of the bag body 100, the tether 200 supports the bag body 100 from the cabin outer side surface 110sb of the bag body 100. That is, when the bag body 100 receives a force from the inside to the outside of the vehicle V, the bag body 100 is less likely to jump out to the outside of the vehicle V. Therefore, in the curtain airbag device 10 according to the present embodiment, the bag body 100 is more easily fastened to the inside of the vehicle V than in an aspect in which the tether 200 is fixed to the cabin inner side surface 110sf of the bag body 100.

### A-2. Operation of Curtain Airbag Device 10

The curtain airbag device 10 operates when the vehicle V collides or rolls over. Specifically, the curtain airbag device 10 injects inflation gas to the bag body 100 by the inflator 300. Accordingly, the bag body 100 stored in the roof side rail portion Rr is inflated. At this time, the tether 200 stored together with the bag body 100 is also stretched at the same time.

In the deployed state, the bag body 100 is deployed to the lower portion of the window portion Wd so as to cover the window portion Wd in the side wall Ws. However, the inflation portion lower end 110d does not cover the lower edge portion Wdd of the window portion Wd. That is, since the inflation portion 110 does not overlap the door trim Dt, the bag body 100 is deployed along the window portion Wd.

In a state in which the bag body 100 is deployed, the tether 200 is provided across the window portion Wd from the front pillar Rrf to the rear pillar Rrr. A part of the tether 200 other than the two end portions 210 is fixed to the bag lower portion 110b, so that the tether 200 holds the bag lower portion 110b. As a result, the bag body 100 is held along the window portion Wd because the upper end 100u is fixed to the roof side rail portion Rr. Accordingly, deformation of the bag body 100 and movement of the inflation portion lower end 110d are reduced. More specifically, when the protected object PO collides with the bag body 100, the tether 200 functions to generate a reaction force against a force of deforming the bag body 100, and thus reduces deformation. This reduces the risk of the protected object PO being released to the outside of the vehicle. Further, the tether 200 holds the bag body 100, so that the bag body 100 is prevented from being separated from the window portion Wd by the swing generated when the protected object PO collides with the bag body 100. This reduces the risk of the protected object PO being released to the outside of the vehicle through the gap between the bag body 100 and the upper end portion Dtu of the door trim Dt.

FIG. 3 is a view illustrating a cross section of the bag body 100 in a deployed state. FIG. 3 illustrates a cross section of the bag body 100 when the bag body 100 is viewed along the backward direction BD. This figure shows a state immediately before a head impactor Im collides with the bag body 100. The head impactor Im in FIG. 3 represents the head impactor used in FMVSS 226 testing. In this standard, it is required to reduce the amount of protrusion of the bag body 100 from the window portion Wd by the collision of the head impactor Im to less than 100 mm.

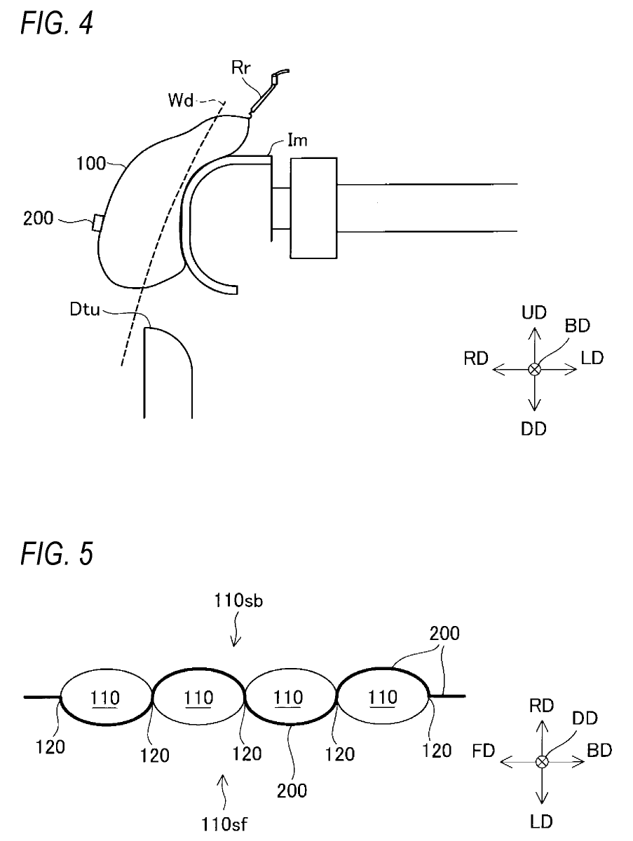

FIG. 4 is a view illustrating a state in which the head impactor Im collides with the bag body 100 illustrated in FIG. 3. The tether 200 is located at the cabin outer side surface 110sb of the bag body 100. Accordingly, when the bag body 100 receives a force toward the outside of the vehicle V due to the collision of the head impactor Im, the tether 200 can effectively reduce the deformation of the bag body 100. Further, the tether 200 is located at the bag lower portion 110b. That is, the tether 200 is likely to be located in the downward direction DD with respect to the head impactor Im. Accordingly, even when the bag body 100 receives a force toward the outside of the vehicle V due to the collision of the head impactor Im, the tether 200 can effectively support the lower end portion 110d of the bag body 100 and can reduce the movement to the outside of the window. As a result, the amount of protrusion of the bag body 100 from the window portion Wd is reduced to less than 100 mm.

As described above, the curtain airbag device 10 according to the present embodiment can protect the protected object PO even when the lower end portion 110d of the bag body 100 is not extended in the downward direction DD.

In such an aspect, the bag body 100 is deployed so as to cover the window portion Wd. Further, the tether 200, which is a belt-shaped member, is implemented such that the two end portions 210 are fixed to the front and rear of the window portion Wd of the vehicle V, and a part other than the two end portions 210 is fixed to the bag lower portion 110b. That is, the curtain airbag device 10 according to the present embodiment reduces deformation of the bag body 100 in the left-right direction of the vehicle V as compared with an aspect in which the tether 200 is not provided. More specifically, the curtain airbag device 10 according to the present embodiment can reduce deformation of the bag body 100 toward the outside of the vehicle V when the bag body 100 receives a force from the inside toward the outside of the vehicle V. Further, the bag body 100 does not cover the lower edge portion Wdd of the window portion Wd. Therefore, the curtain airbag device 10 according to the present embodiment can prevent an increase in the size of the bag body 100 as compared with an aspect in which the lower end portion 110d of the bag body 100 is extended.

By preventing an increase in the size of the bag body 100, the curtain airbag device 10 according to the present embodiment can reduce the cost of the bag body 100. Further, since the amount of inflation gas required to inflate the bag body 100 is also reduced, the curtain airbag device 10 according to the present embodiment can reduce the gas capacity of the inflator 300. That is, the curtain airbag device 10 according to the present embodiment can also reduce the cost required for the inflator 300. In addition, since the bag body 100 has a configuration in which the lower end portion 110d is not extended in the downward direction DD, the shape of the base fabric at the time of cutting out is close to a square. Therefore, the curtain airbag device 10 according to the present embodiment minimizes the waste material of the base fabric. That is, the curtain airbag device 10 according to the present embodiment can improve the material yield as compared with an aspect having the bag body 100 having a structure in which the lower end portion 110d extends in the downward direction DD.

In the present embodiment, the tether 200 is fixed to the non-inflation portion 120. In such an aspect, the tether 200 is fixed to the non-inflation portion 120 that is less likely to be deformed than the inflation portion 110 of the bag body 100. That is, the curtain airbag device 10 according to the present embodiment is designed so as to be easily fixed to the bag body 100 as compared with an aspect in which the tether 200 is fixed to the inflation portion 110 of the bag body 100.

In addition, in a state in which the bag body 100 is deployed, the tether 200 is located on the cabin outer side surface 110sb opposite to the cabin inner side surface 110sf facing the inside of the vehicle V in the bag body 100. With such an aspect, the curtain airbag device 10 according to the present embodiment easily reduces deformation of the bag body 100 toward the outside of the vehicle V. More specifically, when the protected object PO collides with the cabin inner side surface 110sf of the bag body 100, the tether 200 supports the bag body 100 from the cabin outer side surface 110sb of the bag body 100. That is, when the bag body 100 receives a force from the inside to the outside of the vehicle V, the bag body 100 is less likely to jump out to the outside of the vehicle V. Therefore, in the curtain airbag device 10 according to the present embodiment, the bag body 100 is more easily fastened to the inside of the vehicle V than in an aspect in which the tether 200 is fixed to the cabin inner side surface 110sf of the bag body 100.

Further, the tether 200 is implemented such that the two end portions 210 are fixed to the front and rear of the roof side rail portion Rr. In addition, the length of the tether 200 is larger than the length of the roof side rail portion Rr, and is smaller than the shortest length connecting two ends of the tether 200 along the surface of the bag body 100 in the maximum inflated state in the curtain airbag device 10 not including the tether 200. With such an aspect, the curtain airbag device 10 according to the present embodiment can reduce deformation of the bag body 100 and movement of the inflation portion lower end 110d such that the tether 200 extends longer than the shortest length connecting the two end portions 210.

### B. Second Embodiment

FIG. 5 is a view illustrating the tethers 200 located on the cabin outer side surface 110sb and the cabin inner side surface 110sf of the bag body 100. In the embodiment described above, the tether 200 is located on the cabin outer side surface 110sb of the bag body 100 in a state in which the bag body 100 is deployed. Alternatively, the tether 200 may be located on both the cabin inner side surface 110sf and the cabin outer side surface 110sb of the bag body 100. This arrangement is implemented by the tether 200 penetrating the non-inflation portion 120 so as to be provided along a part of the cabin inner side surface 110sf and a part of the cabin outer side surface 110sb.

With such an aspect, since the inflation of both surfaces of the bag body 100 is likely to be uniform on both surfaces, uneven inflation is prevented. Accordingly, the slack in the tether 200 is prevented when the bag body 100 is inflated. More specifically, when the tether 200 is located only on one surface of the bag body 100, the side of the bag body 100 including the surface without the tether 200 is likely to inflate. On the other hand, the side of the bag body 100 including the surface on which the tether 200 is provided is less likely to inflate. As a result, since the tension acting on the tether 200 is reduced, and the tether 200 is likely to sag. However, by providing the tether 200 on both the cabin inner side surface 110sf and the cabin outer side surface 110sb, both surfaces of the bag body 100 are likely to inflate uniformly, and thus the slack in the tether 200 is prevented. Therefore, the curtain airbag device 10 according to the present embodiment can hold the bag body 100 more strongly than in an aspect in which the tether 200 is located only on the cabin outer side surface 110sb. That is, the curtain airbag device 10 according to the present embodiment may more effectively reduce deformation of the bag body 100 and movement of the inflation portion lower end 110d.

### C. Other Embodiment

In the embodiment described above, the tether 200 may be fixed within a range of 1/3 of the bag height H from the inflation portion lower end 110d in the bag lower portion 110b. With such an aspect, the movement of the inflation portion lower end 110d can be more effectively reduced than when the tether 200 is fixed at a position higher than 1/3 of the bag height H. Therefore, in the curtain airbag device 10 according to the present embodiment, a gap between the window portion Wd and the bag body 100 is less likely to be generated.

In the embodiment described above, the length of the tether 200 is smaller than the shortest length connecting the two ends of the tether 200 along the surface of the bag body 100 in the maximum inflated state in the curtain airbag device 10 not including the tether 200. In the present embodiment, the "surface in the maximum inflated state" preferably includes the central portion of a main chamber MC of the bag body 100 shown in FIG. 1. The main chamber MC is a part of the inflation portion 110 provided mainly for protecting the head of the occupant. The main chamber MC is connected to another inflation portion 110 called a sub-chamber SC. In addition to protecting the occupant, the sub-chamber SC is connected to the main chamber MC to adjust the internal pressure of the main chamber MC. Normally, the main chamber MC is designed to inflate more than the sub-chamber SC. The central portion of the main chamber MC is the most inflated portion in the main chamber MC, and is provided at a position of approximately half H/2 of the bag height H.

That is, the shortest length connecting the two ends of the tether 200 along the surface of the bag body 100 in the maximum inflated state including the central portion of the main chamber MC is larger than the shortest length connecting the two ends of the tether 200 along the surface in the maximum inflated state within a range of 1/3 of the bag height H. Therefore, in the present embodiment, since the length of the tether 200 is designed to be smaller than the shortest length connecting the two ends of the tether 200 along the surface in the maximum inflated state including the central portion of the main chamber MC, the tether 200 can more reliably reduce the deformation of the bag body 100 and the movement of the inflation portion lower end 110d.

### D. Other Embodiment

(D1) In the embodiment described above, in the tether 200, one of the two end portions 210 is fixed to the vicinity of the end portion of the front pillar Rrf in the downward direction DD, and the other is fixed to the vicinity of the end portion of the rear pillar Rrr in the downward direction DD. However, it is sufficient that the two end portions 210 of the tether 200 are fixed to the front and rear of the window portion Wd of the vehicle V. For example, the two end portions 210 of the tether 200 may be fixed to central portions of the front pillar Rrf and the rear pillar Rrr.

(D2) In the embodiment described above, a part of the tether 200 other than the two end portions 210 is fixed to the non-inflation portion 120. Alternatively, the part of the tether 200 other than the two end portions 210 may be fixed to the inflation portion 110.

(D3) In the embodiment described above, the length of the tether 200 is larger than the length of the roof side rail portion Rr, and is smaller than the shortest length connecting the two ends of the tether 200 along the surface of the bag body 100 in the maximum inflated state in the curtain airbag device 10 not including the tether 200. Alternatively, the length of the tether 200 may be smaller than the length of the roof side rail portion Rr. For example, the length of the tether 200 may be the length from the central portion of the front pillar Rrf to the central portion of the rear pillar Rrr. Further, the length of the tether 200 may be larger than the shortest length connecting the two ends of the tether 200 along the surface of the bag body 100 in the maximum inflated state in the curtain airbag device 10 not including the tether 200. In such an aspect, since the tether 200 also has higher rigidity than the bag body 100, there is a high chance that the movement and deformation of the bag body 100 can be reduced.

The present disclosure is not limited to the embodiments described above, and can be implemented by various configurations without departing from the gist of the present disclosure. For example, the technical features in the embodiments corresponding to the technical features in the aspects described in the summary of the present disclosure can be replaced or combined as appropriate to solve a part or all of the problems described above or to achieve a part or all of the effects described above. The technical features may be appropriately deleted unless being described as necessary in the present specification.

What is claimed is:

1. A curtain airbag device that is attached to a roof side rail portion of an upper portion of a vehicle, the curtain airbag device comprising:
a bag body configured to be inflated by being supplied with inflation gas to be deployed along a side wall of the vehicle in a downward direction of the vehicle to a lower portion of a window portion provided on the side wall so as to cover the window portion; and
a tether that is a belt-shaped member with two end portions being fixed to front and rear of the window portion of the vehicle, and with a part other than the two end portions being fixed to a bag lower portion that is a portion of the bag body including a lower end of the bag body,
wherein the bag body includes an inflation portion into which the inflation gas is supplied, and a non-inflation portion into which the inflation gas is not supplied, and
wherein, in a state in which the bag body is deployed, an inflation portion lower end does not cover a lower edge portion of the window portion.

2. The curtain airbag device according to claim 1,
wherein the tether is fixed to the non-inflation portion.

3. The curtain airbag device according to claim 2,
wherein the bag body has a cabin inner side surface facing an inside of the vehicle and a cabin outer side surface that is opposite to the cabin inner side surface, and
wherein, in the state in which the bag body is deployed, the tether is located at the cabin outer side surface.

4. The curtain airbag device according to claim 3,
wherein the tether is fixed within a range of 1/3 of a bag height from the inflation portion lower end.

5. The curtain airbag device according to claim 4,
wherein the two end portions are fixed to front and rear of the roof side rail portion, and
wherein a length of the tether is larger than a length of the roof side rail portion, and is smaller than a shortest length connecting two ends of the tether along a surface of the bag body in a maximum inflated state in a curtain airbag device without the tether.
